(19) United States
(12) Patent Application Publication
(10) Pub. No.: US 2025/0068043 A1
(43) Pub. Date: Feb. 27, 2025

(54) UTILITY BOX CAMERA MOUNT

(71) Applicant: Axis AB, Lund (SE)

(72) Inventor: Kent Fransson, Lund (SE)

(21) Appl. No.: 18/943,887

(22) Filed: Nov. 11, 2024

(51) Int. Cl. G03B 17/56; F16M 13/02

(52) U.S. Cl. CPC G03B 17/561; F16M 13/022

(57) ABSTRACT

A camera system may include a utility box having a wall plate, a camera mounted in the utility box, magnets, wherein the magnets generate an attractive force to mount the camera to the wall plate of the utility box, a guide pin protruding from the camera or the wall plate of the utility box, and a recess to receive the guide pin, wherein the recess is located in the camera or in the wall plate of the utility box, wherein the guide pin limits motion of the camera when the camera is mounted on the wall plate of the utility box.

### BACKGROUND

Utility boxes may be found attached to fixtures, such as telephone poles or utility poles. In some instances, monitoring cameras may be placed inside the utility boxes on these utility poles. The monitoring cameras may be concealed within the utility box for viewing an area from a remote monitoring station or for recording of images or video. Utility boxes are subject to vibration from the weather, traffic, sound, etc.

### BRIEF DESCRIPTION OF THE DRAWINGS

The following is a brief description of the drawings.

FIG. 1 is a drawing of an exemplary environment in which methods, systems, and devices described herein may be used;

FIGS. 2A, 2B, 2C, and 2D show the exemplary camera of FIG. 1 from different perspectives;

FIGS. 3A and 3B show the camera of FIGS. 2A-2D being inserted into the utility box of FIG. 1; and

FIGS. 4A, 4B, 4C, and 4D show the camera of FIGS. 2A-2D in a configuration for mounting to a wall of a utility box.

### DETAILED DESCRIPTION

The following detailed description refers to the accompanying drawings. The same reference numbers in different drawings may identify the same or similar elements.

As noted above, monitoring cameras may be placed inside utility boxes mounted on utility poles. The monitoring cameras may be concealed within the utility box for viewing an area from a remote monitoring station or for recording images and/or video. Utility boxes may be subject to vibration from the weather, traffic, sound, etc. In such a case, the camera may become misaligned and may no longer point at the desired location. Cameras within utility boxes may be attached with bolts, clamps, or straps. Installing monitoring cameras may be dangerous, difficult, and/or time consuming.

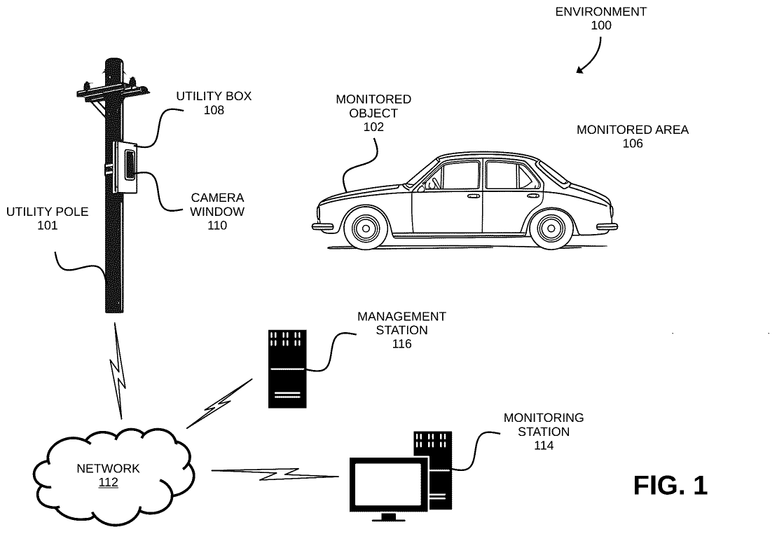

FIG. 1 is a drawing of an exemplary environment 100 in which methods, systems, and devices described herein may be used. Environment 100 may include a utility pole 101 onto which a utility box 108 is mounted. Utility pole 101 may carry communication and/or power cables, for example. Utility box 108 includes a window 110 through which light passes from outside to inside utility box 108. A camera (not shown in FIG. 1) may be mounted inside utility box 108 such that the camera can monitor a monitored area 106 for objects, such as object 102 (e.g., an automobile). Object 102 may include any object, such as a door, a person, an animal, a vehicle, or a license plate on a vehicle. The camera in utility box 108 may communicate with a monitoring station 114 or management station 116 through a network 112 (e.g., the internet). Management station 116 may store the images and/or video from the camera inside of utility box 108. Monitoring station 114 may enable an operator (not shown) to view images and/or video on a display from the camera inside utility box 108. Environment 100 may include many utility poles and boxes (such as utility pole 101 and utility box 108). Management station 116 may manage and store images and/or video from many cameras within the utility boxes for viewing on monitoring station 114.

Utility box 108 may be mounted on a pole (e.g., a telephone or utility pole), a fence, or other suitable structure. Utility box 108 may protect devices and components inside utility box 108. In one configuration, utility box 108 may include a connection box for cables hanging on a wire. Utility box 108 may be pre-existing in that it was initially installed (e.g., without a camera) for a function other than monitoring monitored area 106 (e.g., cable junctions and/or a transformer). Alternatively, utility box 108 may be installed with the intent of using it for a camera. In either case, the camera may be hidden in utility box 108 such that utility box 108 appears to have a function other than for monitoring area 106.

Utility box 108 may be weather resistant to guard the components and devices inside utility box 108 from the elements. For example, utility box 108 may be sealed to provide a degree of water resistance. As such, puncturing utility box 108 may make utility box 108 more vulnerable to weather and the elements. Utility box 108 may also be mounted to utility pole 101 in a way to resist some amounts of vibration from traffic, wind, etc. Mounting cameras into utility box 108 on utility pole 101 may introduce challenges because there may be less space in utility box 108 as compared to other mounting locations (e.g., inside a building).

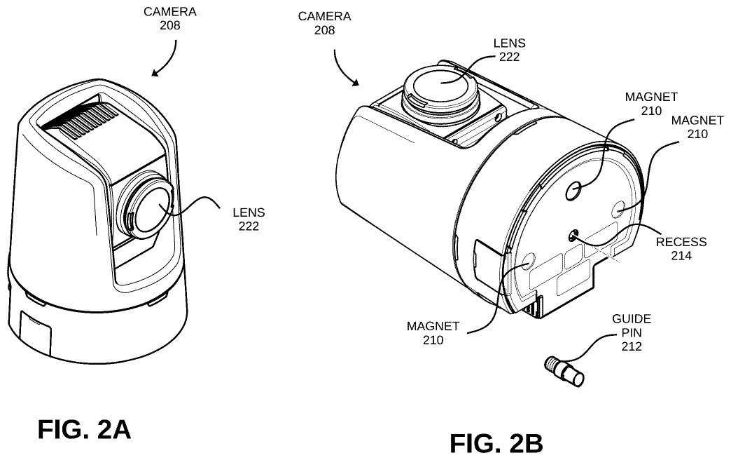

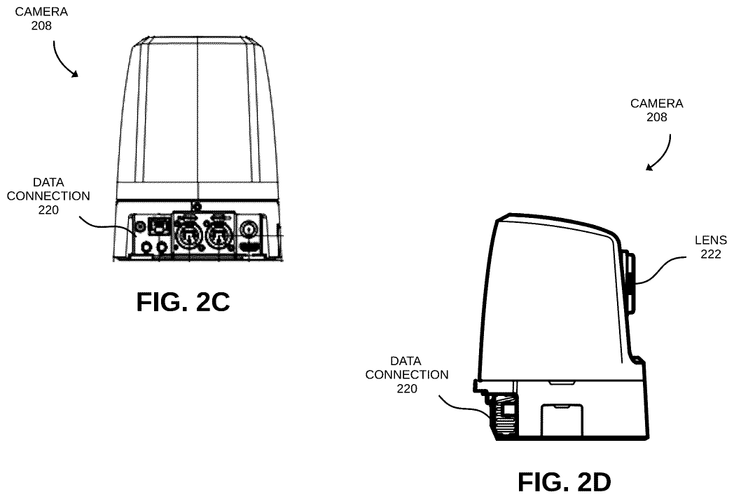

FIGS. 2A, 2B, 2C, and 2D show an exemplary camera 208, such as the camera described in relation to FIG. 1, from different perspectives. FIG. 2A shows the front, right side, and top of camera 208, and FIG. 2B shows the front, right side, and bottom of camera 208. As shown in FIGS. 2A and 2B, camera 208 may include a lens 222 to receive light from monitored area 106 of object 102. In one configuration of camera 208, lens 222 may zoom, pan, and/or tilt left and right (e.g., in azimuth) and/or up and down, for example. Camera 208 may also include an image sensor to capture image and/or video data of object 102 in monitored area 106. Camera 208 may transmit locally stored images and/or video to other devices in environment 100, such as management station 116 and/or monitoring station 114 for an operator to view, for example. Further, camera 208 may be controlled by other devices in environment 100.

FIG. 2C shows the rear of camera 208 and FIG. 2D shows the right side of camera 208. As shown in FIGS. 2C and 2D, data connection 220 may allow camera 208 to communicate with other devices in environment 100 (e.g., through network 112). For example, camera 208 may transmit locally stored images and/or video to management station 116 and/or monitoring station 114 through data connection 220. Camera 208 may also use data connection 220 to send or receive instructions to or from other devices, such as monitoring station 114. In one configuration, data connection 220 may receive power for operation of camera 208 and/or other devices connected to camera 208. Data connection 220 may include an HDMI port, an ethernet cable port, a speaker port, a microphone port, a Universal Serial Bus (USB) port, a power input port, a power output port (e.g., USB-C power delivery), a three gigabit Serial Digital Interface (3G SDI), and/or an antenna port. The ethernet cable port may include a power over ethernet (POE) port. The ethernet cable port may allow for wired communications and the antenna port may allow, for example, wireless communications.

As also shown in FIGS. 2C and 2D, lens 222 and data connection 220 may be on opposite sides from each other on camera 208. That is, lens 222 may be on the front side (e.g., a first side) of camera 208 and data connection 220 may be on the back side (e.g., a second side) of camera 208. As such, the front or first side (with lens 222) is opposite the second or back side (with data connection 220). In one embodiment, camera 208 may be configured to pan lens 222 no more than 180 degrees and/or less than 180 degrees. In this configuration, lens 222 may sweep through the first or front side of camera 208.

Returning to FIG. 2B, camera 208 may include one or more magnets 210 (singular, “magnet 210”), and a recess 214, and be associated with a guide pin 212. Magnets 210 may include a material, such as iron or steel, that attracts other materials (e.g., ferromagnetic materials). In one configuration, magnets 210 generate an attractive force to mount camera 208 to utility box 108. Magnets 210 may be glued, screwed, friction fitted, or added during an injection molding or a 3D printing process.

As shown in FIG. 2B, recess 214 may be located in the base of camera 208. Recess 214 may accept guide pin 212 to facilitate mounting camera 208 in utility box 108. Guide pin 212 may protrude from camera 208 for mounting camera 208 to utility box 108. In one configuration, guide pin 212 may be inserted into recess 214 for mounting (e.g., “mounting recess 214” or “recess 214 for mounting”) camera 208 in utility box 108. In one implementation, recess 214 may include threads (e.g., a threaded hole or threaded opening) configured to accept a screw for mounting camera 208. In the implementation shown in FIG. 2B, guide pin 212 includes threads at one end for screwing guide pin 212 into recess 214 of camera 208 (while the other end protrudes from camera 208). Recess 214 and guide pin 212 may include standard female or male ¼-20 Unified National Coarse (UNC) thread on respective surfaces. Recess 214 and/or guide pin 212 may include other types of threads. In another implementation, recess 214 and/or guide pin 212 do not include threads. For example, guide pin 212 may be retained in recess 214 by a magnet (e.g., at the base of recess 214). In this implementation, guide pin 212 may be configured to pass linearly through recess 214 without engaging threads. In one implementation, if recess 214 includes threads, guide pin 212 may nonetheless have a diameter less than the diameter of any threads in recess 214 and guide pin 212 may pass linearly through recess 214 without engaging threads.

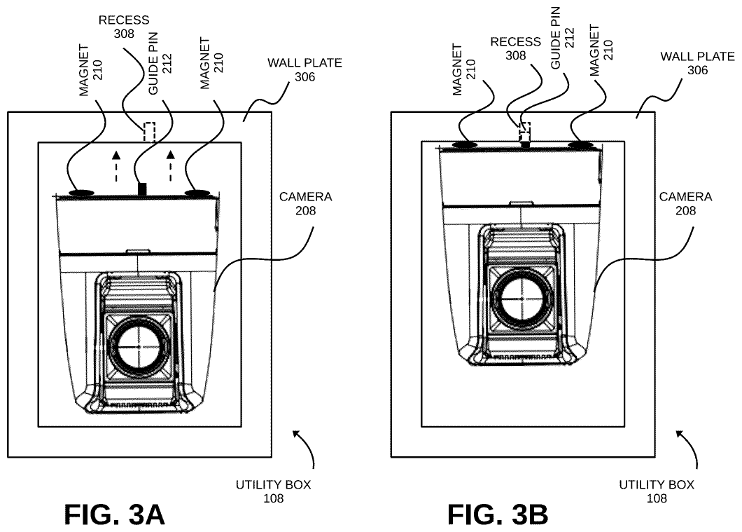

As described, guide pin 212 may be removably attached to camera 208 (such as by screwing) to camera 208. In another configuration, guide pin 212 may be permanently attached or fixed to camera 208. For example, guide pin 212 may be welded or glued to camera 208. As another example, the housing of camera 208 may integrally include guide pin 212 (e.g., the housing and guide pin 212 may be molded as one). In these implementations, recess 214 may not be present or may be hidden from view while guide pin 212 protrudes from the base of camera 208. Guide pin 212, for example, may protrude from camera 208 for a distance shorter than 5 cm, 4 cm, 3 cm, 2 cm, or 1 cm. Guide pin 212 may also be in the form of a convex bump in camera 208 that matches a concave recess 308 in a wall plate 306 (see FIGS. 3A and 3B). Likewise, guide pin 212 may also be in the form of a convex bump in wall plate 306 that matches a concave recess 214 (e.g., “receiving recess 214” or “recess 214 for receiving”) in camera 208.

In one configuration, camera 208 may be mounted in utility box 108 by using a threaded bolt to attach camera 208 to the interior of utility box 108. If camera 208 includes recess 214 with threads, for example, then the bolt with threads may be rotated (e.g., with a tool) to attach camera 208 to a wall plate of utility box 108 (e.g., wall plate 306 shown in FIG. 3A). With limited space, however, the tool to turn the threaded bolt may be cumbersome. Alternatively, camera 208 may also be rotated while the bolt is kept stationary. Rotating camera 208, however, may introduce additional complications for the installer. Because lens 222 may rotate no more than 180 degrees (e.g., lens 222 cannot rotate 360 degrees), the installer may find it necessary to point lens 222 forward, leaving data connection 220 facing toward the back of utility box 108 without sufficient room to attach the cables after mounting camera 208 to utility box 108. Thus, it may be necessary to connect cables to data connection 220 before camera 208 is mounted in utility box 108. The act of rotating camera 208, however, may twist the cables. In addition, it may also be useful to place lens 222 close to the front glass of utility box 108 (e.g., to reduce reflection). As such, it may not be practical to install camera 208 such that data connection 220 is facing forward because of insufficient room for the cables.

FIGS. 3A and 3B show camera 208 of FIGS. 2A-2D being mounted inside utility box 108 of FIG. 1. In the example shown in FIGS. 3A and 3B, guide pin 212 protrudes from camera 208 for mounting camera 208 to utility box 108. As shown, utility box 108 includes wall plate 306 and wall plate 306 includes recess 308 (shown in FIGS. 3A and 3B with a dashed line). The installer may place camera 208 into utility box 108 with guide pin 212 protruding upward. The installer may lift camera 208 whereby guide pin 212 is received by recess 308 (e.g., receiving recess 308). That is, guide pin 212 mates with recess 308 in wall plate 306. Magnets 210 generate an attractive force such that camera 208 suspends from wall plate 306 securely as shown in FIG. 3B. In FIG. 3B, the portion of guide pin 212 that is not directly visible is shown with a dashed line. As such, the installer may secure camera 208 to utility box 108 without rotating camera 208 relative to utility box 108. When guide pin 212 mates with recess 308 in utility box 108, the mating may limit motion of camera 208 when camera 208 is mounted in utility box 108. The motion may be limited depending on the play between recess 214 and/or recess 308 and guide pin 212. In this example, the portion of guide pin 212 that mates with recess 214 and recess 308 do not include threads.

As noted above, guide pin 212 may be integral to camera 208 and recess 214 may not be visible or present in camera 208. In this case, an installer would not necessarily have to attach guide pin 212 to camera 208. Alternatively, guide pin 212 may be attached by the installer to camera 208 (e.g., by inserting guide pin 212 into recess 214) before mounting camera 208 to wall plate 306 of utility box 108 as described with respect to FIGS. 3A and 3B. For example, as shown in FIG. 2B, guide pin 212 may include threads on one end such that guide pin 212 may be screwed into mounting recess 214. In this implementation, the second end of guide pin 212 protruding from camera 208 may not include threads.

Because data connection 220 may be on the back of camera 208, the installer may attach cables to camera 208 before mounting camera 208 into utility box 108. In this case, because cables are attached to data connection 220 before installing camera 208 into utility box 108, it may not be possible to rotate camera 208 if a threaded screw were to be used to connect camera 208 to wall plate 306. Further, it may also not be possible to install camera 208 such that data connection 220 is facing forward for connecting cables after mounting camera 208 into utility box 108 because this may either place lens 222 farther away from window 110 or place lens 222 such that it cannot view through window 110. Thus, magnets 210 generate an attractive force such that camera 208 suspends from wall plate 306 securely and the installer may secure camera 208 to utility box 108 without rotating camera 208 relative to utility box 108.

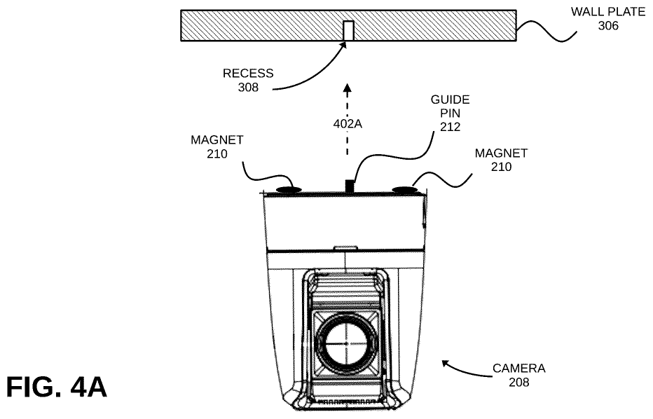

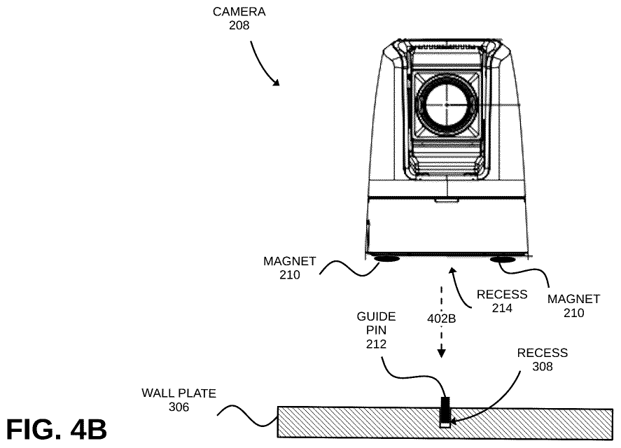

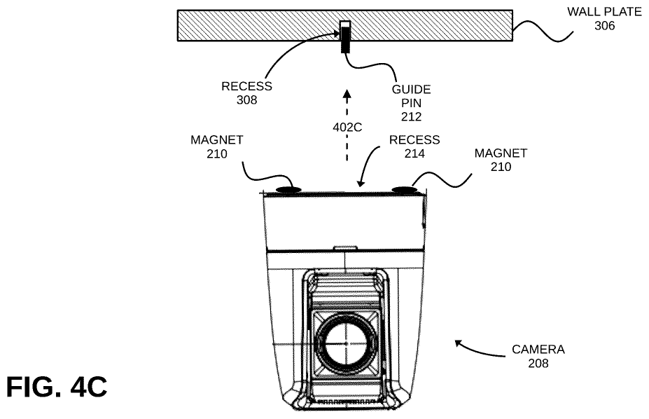

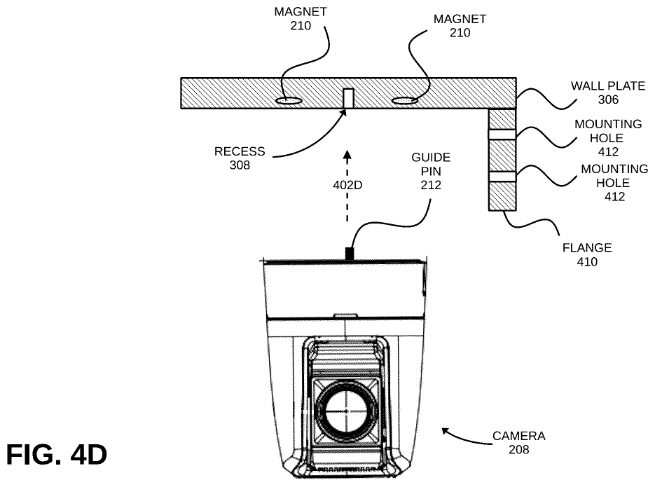

FIGS. 4A-4D show the cross section of wall plate 306 within the interior of utility box 108. In one configuration, wall plate 306 may be integral to utility box 108 and may form a wall of utility box 108. Alternatively, wall plate 306 may be a separate, removable plate that itself may be mounted in utility box 108. Wall plate 306 may include magnetic material (e.g., ferromagnetic material) to which magnets 210 in camera 208 may adhere for mounting camera 208. Alternatively, or additionally, wall plate 306 may include magnets 210 to adhere to other magnets (e.g., in camera 208) or to adhere to magnetic material (e.g., ferromagnetic material) in camera 208. That is, camera 208 may include magnets 210, wall plate 306 may include magnets 210, or both camera 208 and wall plate 306 may include magnets. Likewise, wall plate 306 may include magnetic material (e.g., ferromagnetic material), camera 208 may include magnetic material (e.g., ferromagnetic material), or both camera 208 and wall plate 306 may include magnetic material (e.g., ferromagnetic material).

FIG. 4A shows camera 208 configured to be mounted to wall plate 306 with wall plate 306 acting as a ceiling and guide pin 212 attached to camera 208 pointing up. As shown in FIG. 4A, wall plate 306 includes recess 308 to receive guide pin 212 (e.g., “receiving recess 308” or “recess 308 for receiving”). In this configuration, guide pin 212 protrudes from camera 208. Guide pin 212 may be integrally formed as part of camera 208 (e.g., glued, welded, and/or integrally molded).

Alternatively, FIG. 4B shows camera 208 configured to be mounted to wall plate 306 with wall plate 306 acting as a floor. As shown in FIG. 4B, guide pin 212 has been inserted into recess 308 of wall plate 306. In this configuration, guide pin 212 may be inserted into recess 308 for mounting (e.g., mounting recess 308 or recess 308 for mounting) camera 208 in utility box 108. In one embodiment, guide pin 212 may have been removably attached to wall plate 306. For example, guide pin 212 may have been screwed into mounting recess 308 in wall plate 306. As such, mounting recess 308 may include threads on its inner surface that match the threads on guide pin 212. Or, the installer may have placed guide pin 212 into mounting recess 308 with guide pin 212 being held in place by a magnet (e.g., at the base of recess 308). Alternatively, guide pin 212 may be integrally formed as part of wall plate 306 (e.g., glued, welded, and/or integrally molded) and recess 308 may be hidden or not present.

FIG. 4C, like FIG. 4A, shows camera 208 configured to be mounted to wall plate 306 with wall plate 306 acting as a ceiling. As shown in FIG. 4C, guide pin 212 has been inserted into recess 308 of wall plate 306. In this configuration, guide pin 212 may be inserted into recess 308 for mounting (e.g., “mounting recess 308” or “recess 308 for mounting”) camera 208 in utility box 108. In one embodiment, guide pin 212 may be integrally formed as part of wall plate 306 (e.g., glued, welded, and/or integrally molded) and recess 308 may be hidden or not present. Alternatively, guide pin 212 may have been removably attached to wall plate 306. For example, guide pin 212 may have been screwed into mounting recess 308 in wall plate 306. Or, the installer may have placed guide pin 212 into mounting recess 308 with guide pin 212 being held in place by a magnet (e.g., at the base of recess 308).

If utility box 108 is being retrofitted to house camera 208, puncturing wall plate 306 to form receiving recess 308 risks damaging utility box 108, making it more vulnerable to the elements. As shown in FIG. 4D, wall plate 306 may be L-shaped and may be a separate, removable plate that itself may be mounted in utility box 108. As such, wall plate 306 may be removably attached to utility box 108. In this configuration, wall plate 306 includes a flange 410 with a mounting hole or holes 412. Screws or bolts (not shown) may removably connect wall plate 306 to a utility box 108. In the case of wall plate 306 in FIG. 4D, wall plate 306 includes magnets 210 for mounting camera 208 (rather than or in addition to camera 208 including magnets 210). As shown in FIG. 4D, wall plate 306 includes recess 308 to receive guide pin 212. In this configuration, guide pin 212 protrudes from camera 208. Guide pin 212 may be integrally formed as part of camera 208 (e.g., glued, welded, and/or integrally molded). Alternatively, guide pin 212 may have been removably attached to camera 208. For example, guide pin 212 may have been screwed into mounting recess 214 in camera 208. Or, the installer may have placed guide pin 212 into mounting recess 214 with guide pin 212 being held in place by a magnet (e.g., at the base of recess 214).

An installer may move camera 208 in the direction of the dashed arrows 402A-D to install camera 208 into utility box 108 (e.g., up in FIGS. 4A, 4C, and 4D; and down in FIG. 4B). Because magnets 210 generate force to attract camera 208 to wall plate 306, when magnets 210 are sufficiently close to wall plate 306 (or camera 208), then the magnetic force retains the attachment of camera 208 to wall plate 306 such that camera 208 does not fall from wall plate 306. Once camera 208 is mounted in utility box 108, when guide pin 212 mates with receiving recess 214 of camera 208 and/or receiving recess 308 in wall plate 306 of utility box 108, the mating may limit motion of camera 208 when camera 208 experiences vibration. For example, in the case of vibration, guide pin 212 may minimize the motion of camera 208 horizontally.

In one configuration, magnets 210 may be mounted only in or on wall plate 306 and camera 208 may include magnetic material (e.g., ferromagnetic material) for magnets 210 to adhere to. Alternatively, magnets 210 may be mounted only in or on camera 208 and wall plate 306 may include ferromagnetic material for magnets 210 to adhere to. In yet another configuration, both camera 208 and wall plate 306 may include magnet 210 which adhere to each other and/or to opposite ferromagnetic parts of the camera 208 and the wall plate 306.

Recess 214 may provide functions other than those related to guide pin 212. For example, recess 214 may accept a double-ended screw that also screws into a threaded hole in mounting plate 306. This double-ended screw may require a special tool for screwing or may require rotating camera 208 when mounting, which could impose difficulties for the installer in tight spaces such as those found in utility box 108. As such, the embodiments described above may take advantage of a pre-existing hole in camera 208 for mounting camera 208 in tight spaces, such as in utility box 108.

In some implementations, camera 208 and/or wall plate 306 may include more than one guide pin 212. Likewise, camera 208 and/or wall plate 306 may include more than one receiving recess (recess 308 or recess 214) that mate with the multiple guide pins 212. This arrangement may be useful to prevent rotation of camera 208 that may result from vibrations, for example.

The terms “front”, “rear”, “back”, “top”, “bottom”, “horizontal”, “vertical”, “up”, and “down”, as used herein, are relative and not absolute terms. For example, camera 208 may be mounted upside down in utility box 108 whereby the top becomes the bottom and vice versa relative to utility box 108.

In this specification, various preferred embodiments have been described with reference to the accompanying drawings. It will be evident that modifications and changes may be made thereto, and additional embodiments may be implemented, without departing from the broader scope of the invention as set forth in the claims that follow. The specification and drawings are accordingly to be regarded in an illustrative rather than restrictive sense.

In the above, while a series of actions, messages, and/or signals, have been described with reference to a process or method, the order of the actions, messages, and signals may be modified in other implementations. In addition, non-dependent actions may be performed in parallel or in a different order. Furthermore, each of the actions may represent or include one or more other actions.

Use of ordinal terms such as “first,” “second,” or “third” in the claims to modify a claim element does not by itself connote any priority, precedence, or order of one claim element over another, the temporal order in which acts of a method are performed, the temporal order in which instructions executed by a device are performed, etc., but are used merely as labels to distinguish one element having a certain name from another element having a same name (but for use of the ordinal term) to distinguish the claim elements.

No element or block used in the present application should be construed as critical or essential to the implementations described herein unless explicitly described as such. Also, as used herein, the term “exemplary,” means “an example” and articles “a,” “an,” and “the” are intended to include one or more items. Further, the phrase “based on” is intended to mean “based, at least in part, on” unless explicitly stated otherwise.

1. A camera system comprising:
a utility box having a wall plate;
a camera mounted in the utility box;
one or more magnets, wherein the magnets generate an attractive force to mount the camera to the wall plate of the utility box;
a guide pin protruding from the camera or the wall plate of the utility box; and
a recess to receive the guide pin, wherein the recess is located in the camera or in the wall plate of the utility box, wherein the guide pin limits motion of the camera when the camera is mounted on the wall plate of the utility box.

2. The camera system of claim 1, wherein the wall plate is a ceiling plate or a floor plate and the guide pin limits horizontal motion of the camera when the camera is mounted on the ceiling plate or the floor plate of the utility box.

3. The camera system of claim 1,
wherein the camera includes the recess to receive the guide pin,
wherein the recess includes threads configured to receive a screw for mounting the camera, and
wherein the guide pin does not include threads and is configured to pass linearly through the recess without engaging the threads.

4. The camera system of claim 1, wherein the one or more magnets are mounted in or on the wall plate or the one or more magnets are mounted in or on the camera.

5. The camera system of claim 4, wherein the wall plate includes ferromagnetic material, and the camera includes the one or more magnets.

6. The camera system of claim 4, wherein the camera includes ferromagnetic material, and the wall plate includes the one or more magnets.

7. The camera system of claim 4, wherein the camera and the wall plate include ferromagnetic material.

8. The camera system of claim 4, wherein the camera and the wall plate each include at least one of the one or more magnets.

9. The camera system of claim 4, wherein the one or more magnets are glued, screwed, or added during a molding or a 3D printing process.

10. The camera system of claim 1, wherein the wall plate is integral to the utility box.

11. The camera system of claim 1, wherein the wall plate is removably mounted to an interior of the utility box.

12. The camera system of claim 11, wherein the removably mounted wall plate is L shaped.

13. The camera system of claim 1, wherein the guide pin protrudes from a base of the camera, and wherein the recess is located in the wall plate of the utility box.

14. The camera system of claim 13, wherein the guide pin protrudes from the wall plate of the utility box, and wherein the recess is located on a base of the camera.

15. A camera configured to be mounted in a utility box, the camera comprising:
one or more magnets, wherein the magnets generate an attractive force to mount the camera to a wall plate of the utility box;
a threaded screw hole to receive a first end of a guide pin,
wherein the first end of the guide pin includes threads to engage the screw hole to connect the guide pin to the camera,
wherein the second end of the guide pin is configured to be received by a recess in a wall plate of the utility box, and
wherein the guide pin limits motion of the camera when the camera is mounted on the wall plate of the utility box.

16. The camera of claim 15, wherein the wall plate is a ceiling plate or a floor plate and the guide pin is configured to limit horizontal motion of the camera when the camera is mounted on the ceiling plate or the floor plate of the utility box.

17. A camera configured to be mounted in a utility box using magnetic force, the camera comprising:
a guide pin,
wherein a first end of the guide pin is connected to the camera,
wherein a second end of the guide pin is configured to be received by a recess in a wall plate of the utility box, and
wherein the guide pin limits motion of the camera when the camera is mounted on the wall plate of the utility box.

18. The camera of claim 17, comprising one or more magnets, wherein the magnets generate an attractive force to mount the camera to a wall plate of the utility box.

19. The camera of claim 17, comprising a threaded screw hole to receive the first end of the guide pin,
wherein the first end of the guide pin includes threads to engage the screw hole to connect the guide pin to the camera.

20. The camera of claim 17, wherein the wall plate is configured to be removably attached to the utility box.
